(19) United States
(12) Patent Application Publication
(10) Pub. No.: US 2026/0310812 A1
(43) Pub. Date: Oct. 8, 2026

(54) DATA RISK INTELLIGENCE ENVIRONMENT

(71) Applicant: Tradelok, Inc., Walnut Creek, CA (US)

(72) Inventors: Anjani Gali, San Francisco, CA (US); Vivek Ganti, Walnut Creek, CA (US)

(21) Appl. No.: 19/636,564

(22) Filed: Apr. 1, 2026

Related U.S. Application Data
(60) Provisional application No. 63/782,898, filed on Apr. 3, 2025.

(51) Int. Cl. G06F 21/62

(52) U.S. Cl. CPC G06F 21/6218

(57) ABSTRACT

Systems and methods for data risk intelligence and compliance are described. An example data risk intelligence and compliance system includes a memory device and at least one processing device configured through execution of computer-readable instructions on the memory device to receive a message including a file attachment, apply IP controls to the message and the file attachment, remove and store the file attachment based on the IP controls, and send the message with a secure link to the file attachment based on the IP controls. To apply the IP controls, the processing device can also extract the file attachment from the message, classify the file attachment using an AI model, perform an IP and trade compliance check to assess whether the file attachment can be shared, generate the secure link to the file attachment, and insert the secure link into the message in place of the file attachment.

### BACKGROUND

Virtual data rooms (VDRs) and other file collaboration platforms are online repositories used for storing, managing, and sharing sensitive documents, typically in business transactions such as mergers and acquisitions, due diligence, and legal proceedings. Such platforms provide access to confidential files, enabling authorized users to review documents while enforcing some security measures such as permission-based restrictions.

However, the platforms are often cumbersome to use due to their manual setup, complex navigation interfaces, and challenging or time-consuming user experiences. Users must frequently upload, categorize, and manage files manually, which can be time-consuming and prone to human error. Additionally, the need for separate credentials and multi-step authentication for each VDR instance adds friction to the workflow. As a result, organizations face operational inefficiencies and increased administrative overhead when using VDRs for managing sensitive information. Collaboration may take place over e-mail, due to the convenience of e-mail, however it is often challenging to enforce robust processes to control the leakage of intellectual property through e-mail collaboration.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 illustrates an example diagram of a networked computing environment for data risk intelligence and compliance according to various aspects of the embodiments.

FIG. 2 illustrates an example method for data risk intelligence and compliance according to various aspects of the embodiments.

### DETAILED DESCRIPTION

As noted above, virtual data rooms (VDRs) and other file collaboration platforms can be used for storing, managing, and sharing sensitive documents, typically in business transactions such as mergers and acquisitions, due diligence, and legal proceedings. Such platforms provide access to confidential files, enabling authorized users to review documents while enforcing some security measures such as permission-based restrictions. However, the platforms are often cumbersome to use due to their manual setup, complex navigation interfaces, and challenging or time-consuming user experiences. Users must frequently upload, categorize, and manage files manually, which can be time-consuming and prone to human error. Additionally, the need for separate credentials and multi-step authentication for each VDR instance adds friction to the workflow. As a result, organizations face operational inefficiencies and increased administrative overhead when using VDRs for managing sensitive information. Collaboration may take place over e-mail, due to the convenience of e-mail, however it is often challenging to enforce robust processes to control the leakage of intellectual property through e-mail collaboration.

In the context outlined above, computing systems and networked environments for the protection of intellectual property (IP) of various forms, including IP related to inventions, patents, trademarks, copyrights, trade secrets, and other IP which may be deployed as a service to companies is described herein.

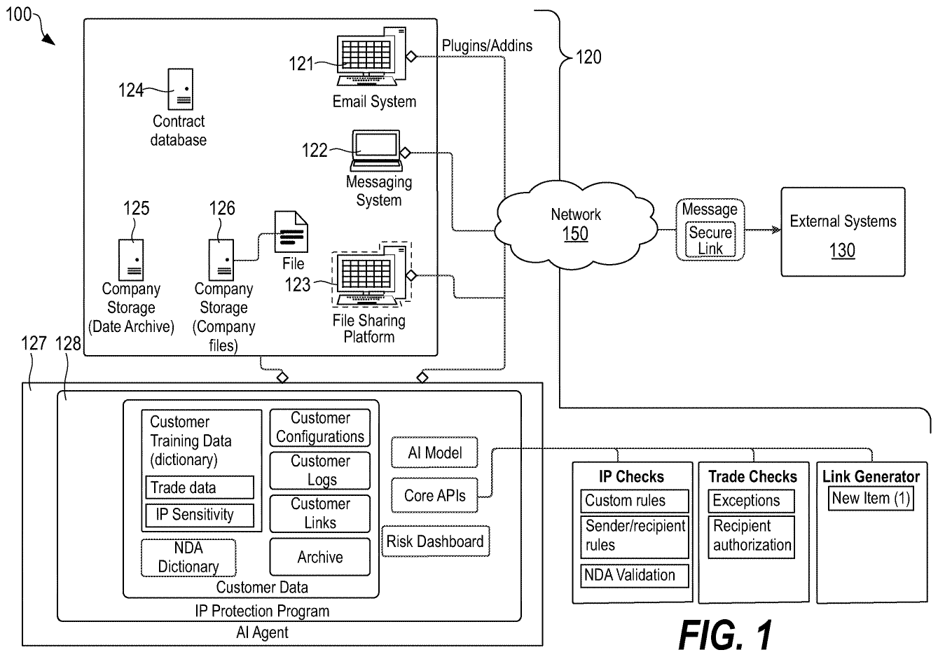

FIG. 1 illustrates an example diagram of a networked computing environment 100 for data risk intelligence and compliance according to various aspects of the embodiments. The networked computing environment 100 includes a company network 120, a data network 150 (also “network 150”), and external systems 130, among possibly other devices and systems. The networked computing environment 100 is depicted as a representative example. The networked computing environment 100 can include other components that are not shown and omit one or more of the components shown in some cases. The networked computing environment 100 can also be implemented in other logical or structural arrangements. While FIG. 1 depicts representative components, the computing environment 100 can include additional computing infrastructure not explicitly shown, such as backend servers, distributed file storage systems, metadata indexing services, monitoring layers, and specialized client applications.

The company network 120 can be embodied by computing environment utilized by a business or enterprise, comprising a combination of on-premises computing resources and cloud-based services. The enterprise may also rely on external providers for contract management, with a contract management system responsible for storing and managing various contracts and agreements. Enterprises typically subscribe to a range of enterprise software services, including e-mail, file collaboration tools, cloud storage, and instant messaging platforms. The company network 120 may encompass multiple instances of cloud-based and on-premises storage solutions to securely store and manage company data, as described herein.

The company network 120 can be embodied as one or more computers, computing devices, or computing systems. The company network 120 can include one or more computing devices arranged, for example, in one or more server or computer banks. The computing device or devices can be located at a single installation site or distributed among different geographical locations. The company network 120 can include a plurality of computing devices that together embody a hosted computing resource, a grid computing resource, or other distributed computing arrangement. In some cases, the company network 120 can be embodied as an elastic computing resource where an allotted capacity of processing, network, storage, or other computing-related resources varies over time.

The company network 120 can also include or correspond to one or more virtualized server instances that are created in order to execute the functionality described herein. The company network 120 can be organized into any number of private partitions (e.g., private cloud partitions), public partitions (e.g., public cloud partitions), and hybrid public/private partitions to support the services for different users, parties, or organizations. The company network 120 can also be embodied, in part, as various functional (e.g., computer-readable instruction), logic (e.g., device, circuit, or processing circuit), or functional and logic elements that can be executed by the company network 120 to direct the computing systems of the company network 120 to perform aspects of the examples described herein.

The network 150 can include the Internet, intranets, extranets, wide area networks (WANs), local area networks (LANs), wired networks, wireless networks, cable networks, satellite networks, other suitable networks, or any combinations thereof. The company network 120 can communicate with other devices coupled to the network 150 using various data transfer protocols and systems interconnect frameworks, such as hypertext transfer protocol (HTTP), simple object access protocol (SOAP), representational state transfer (REST), real-time transport protocol (RTP), real time streaming protocol (RTSP), real time messaging protocol (RTMP), user datagram protocol (UDP), internet protocol (IP), transmission control protocol (TCP), other protocols and interconnect frameworks, and combinations thereof. The network 150 can include connections to any number and type of network hosts or devices, such as website servers, file servers, cloud computing resources, databases, data stores, or any other network or computing architectures.

The external systems 130 are representative of one or more external client devices or systems of one or more external users, businesses, or enterprises. The external systems 130 can include one or more computing devices, processing circuits, or processor-based devices or systems, including those embodied in the form of servers, desktop computers, a laptop computers, personal digital assistants, wearable computing devices, cellular telephones, tablet computers, embedded control systems, command-line interface devices, terminal-based systems, virtual desktop infrastructures (VDIs), edge computing nodes, or related computing devices or combinations thereof. The external systems 130 can include peripheral devices or components, such as display interfaces and input/output devices.

The external systems 130 can execute one or more applications, such as the Microsoft Outlook® e-mail client, that interacts with the e-mail, messaging, file sharing, and other systems of the company network 120 using suitable protocols via the network 150. As other examples, the external systems 130 can execute hypertext-based network browsers, such as, but not limited to, Internet Explorer®, Firefox®, Chrome®, Safari®, or Silk® browsers, among other types of browsers. The external systems 130 can also execute other types of applications, such as messaging clients, document editors or viewers, file browsers, or other applications or application extensions for other purposes. When executed on the external systems 130, the applications on the external systems 130 can interpret and render a webpage or e-mail, display content, or other present another user interface on a display.

Among other devices or systems, the company network 120 includes an e-mail system 121, a messaging system 122, a file sharing platform 123, a contract database 124, a company storage data archive 125, and a company file storage system 126. The company network 120 also includes an artificial intelligence (AI) agent 127 with an IP protection system 128, including customer data, an AI model, core APIs, and a risk dashboard engine. In some cases, the AI agent 127 and IP protection system 128 can be implemented as a single or merged component, and the IP protection system 128 can also be implemented without the artificial intelligence (AI) agent 127 in some implementations. The contract database 124, company storage data archive 125, company file storage system 126, and related storage and database systems can store a range of different data, such as trade data, IP training data, text, document, publishing, financial, geographic information system, graphics, presentation, script, spreadsheet, webpage, image, media, backup, archive, database, compressed and uncompressed disk, computer aided design, design automation, and other types of data files, in any suitable file format, without limitation.

The IP protection system 128 incorporates an AI model designed to classify various forms of content, including messages, e-mails, data files, and other content, as well as a risk management and compliance dashboard. The IP protection system 128 may also utilize customer-specific data, including training data that enables an AI classifier to accurately categorize the customer's information. This training data may include keywords, weighted parameters, or other classification inputs used by the AI model. It may further include trade data and IP training data. The trade data may define classification rules based on Export Control Classification Numbers (ECCNs), ensuring compliance with regulatory requirements. The IP training data may consist of a curated list of keywords or phrases representing concepts deemed sensitive to the company.

Among other components, the IP protection system 128 also includes a non-disclosure agreement (NDA) dictionary in the example shown, which is generated by analyzing contracts and other documents stored within the contract management database. The NDA dictionary may contain a list of authorized companies permitted to receive confidential information, along with the corresponding timeframes for authorization. It may also include a list of e-mail domains associated with each authorized company. The NDA dictionary is generated by classifying and extracting relevant details from contracts stored within the customer's contract management database. The IP protection system 128 further incorporates customer configurations, which consist of a set of features and rule sets customized by the customer to tailor the system's deployment within their environment. The IP protection system 128 also incorporates customer logs, customer links, and an archive of other data.

The IP protection system 128 includes a set of core APIs responsible for processing and securing shared data. These APIs ingest files, recipient information, sender details, and other contextual metadata related to file-sharing activities. Upon ingestion, the core APIs perform various checks and data validation processes to ensure compliance with security policies. For example, the core APIs may execute an IP check, a trade control check, or other data security checks. An IP check involves verifying whether the shared data is authorized for transmission to the intended recipient by cross-referencing the ingested data with NDA records. NDA records specify which recipients are authorized to receive specific content and define the timeframes within which such sharing is permitted. The IP checks may also evaluate whether the sender is permitted to share sensitive information and whether the recipient is authorized to receive it.

Additionally, the core APIs leverage the AI model to classify the content of ingested files based on customer training data. For instance, if an ingested file is classified as highly sensitive IP based on the customer's training data, the system may trigger IP security checks to alert administrators or block the file from being shared externally. Similarly, the APIs may classify the file according to trade regulations, enforcing trade compliance rules by blocking unauthorized exports. The AI model may represent multiple AI models such as, for example, a classifier that classifies sensitive keywords, a classifier that classifies sensitive data, an analyzer that checks if the attachment is highly sensitive which generates the sensitive score, etc.

The core APIs can also generate secure access links to files, embedding them within messages or other communications sent from the company to external systems and recipients. These files may be hosted within the company network 120 or stored in an archive associated with the IP protection system 128.

The IP protection system 128 may be deployed by integrating with the company network 120. This integration can be achieved through various plugins, add-ons, or other system integrations, enabling the core APIs of the IP protection system 128 to seamlessly connect with the customer's existing file-sharing tools. For example, an e-mail plugin can be implemented to automatically invoke the core APIs whenever an email is sent using the e-mail system of the company network 120. When a user of the company network 120 composes an e-mail, for example, relevant contextual data, including sender details, recipient information, file attachments, and message body content, may be passed through the plugin to the core APIs.

As another example, plugins or add-ons may be added to enterprise applications that facilitate a shared workspace (e.g., a collaboration platform). This may include product management tools, project management tools, or other collaboration platforms where users from the same or different companies can interact with each other. The collaboration platform may allow a user to attach a file within a shared workspace, where the IP Protection system 128 removes the file and inserts a link instead of the file while applying IP controls or trade controls. In this case, the message is a body of text within a collaboration platform that is accessible to various users.

The core APIs can then process messages, including e-mails, text messages, and other messages in several ways, including extracting file attachments before the e-mails or messages are sent, classifying the file using the AI model to determine IP sensitivity or trade classification, performing IP and trade compliance checks to assess whether the file can be shared with the intended recipient, and generating a secure link to the file instead of attaching it directly to the email. By replacing file attachments with secure links, the system reduces risk associated with sharing sensitive content externally. Additionally, access control mechanisms can be enforced, such as setting an expiration time on the link, ensuring that access is revoked after a specified duration.

The IP protection system 128 provides a secure, controlled environment for sharing sensitive data while enforcing strict access controls and compliance requirements. The IP protection system 128 ensures that shared files remain read-only and non-downloadable, preventing unauthorized distribution, modification, or offline storage. This is achieved by implementing virtualized file access mechanisms that render files within a controlled viewer environment, eliminating the ability to download, print, or screen capture the content while maintaining usability for authorized users. These IP controls may be dependent upon an IP sensitivity classification of the file. For example, files that are not deemed as highly sensitive may be shared without some or all of these IP controls while more sensitive files may include some or all of these IP controls.

To further enhance security, the IP protection system 128 incorporates an automatic access revocation feature. This ensures that access to sensitive files is dynamically controlled based on predefined policies, time limits, or security events. For example, if a recipient's authorization expires or if a security risk is detected, the system can instantly revoke access, preventing further viewing or interaction with the document. This feature is particularly useful for managing time-sensitive contracts, confidential business negotiations, and regulatory compliance scenarios.

The IP protection system 128 also includes an active NDA verification mechanism. Before granting access to sensitive content, the system automatically cross-references the recipient's e-mail domain or credentials with a centralized NDA database or dictionary. If a valid NDA is not in place, access is denied until the necessary legal agreements are signed. This ensures that confidential information is only shared with parties who have explicitly agreed to contractual confidentiality obligations.

To enable context-aware access controls, the system utilizes an AI-based classification and tagging engine. The AI model analyzes the content of documents and automatically assigns sensitivity labels based on predefined classification rules. This allows for conditional access controls, where document visibility and permissions can be dynamically adjusted based on factors such as recipient role, geographic location, contractual obligations, or regulatory compliance requirements.

For enhanced content integrity and traceability, the IP protection system 128 can apply watermarking or related labeling to documents. These dynamic watermarks include identifiers such as recipient email, timestamp, and access metadata, ensuring that any unauthorized disclosures can be traced back to the source. Watermarks are applied in a way that makes removal difficult without damaging the document's integrity, further discouraging unauthorized distribution.

To ensure comprehensive oversight, the IP protection system 128 maintains robust audit logs that track all interactions with protected content. These logs capture user identities, timestamps, access duration, attempted downloads, and any modifications to access permissions. This creates a tamper-proof record of all activity, supporting compliance audits, forensic investigations, and regulatory reporting requirements.

The IP protection system 128 also automates certificate of destruction workflows for managing document lifecycle policies. When sensitive documents reach the end of their retention period or become obsolete, the system automatically triggers a certificate of destruction process, ensuring secure deletion while maintaining a verifiable record of destruction. This feature helps organizations comply with data retention policies, industry regulations, and legal mandates regarding the proper disposal of confidential information.

By combining advanced access controls, AI-driven classification, automated compliance enforcement, and detailed audit tracking, the IP protection system 128 provides a robust solution for enterprises seeking to protect intellectual property, trade secrets, and other sensitive business data in a highly regulated and security-conscious environment.

The risk management and compliance dashboard provides a centralized interface for monitoring, auditing, and enforcing security controls around the access and sharing of sensitive data within an organization. The IP protection system 128 is designed to enhance visibility, enforce security policies, and support legal and compliance efforts by offering granular access controls, real-time analytics, and forensic investigation capabilities. The risk management and compliance dashboard is built from the various logs generated from the way files are provided to recipients and the way recipients interact with those files. These logs are stored as customer data. Each time the core APIs are invoked to share a file, a record is created indicating the sender's identity, information about the file, information about the recipient, and other contextual information such as time stamps and which computing resources/systems were used. After a link is generated for the file, the IP protection system 128 tracks how recipients interact with the link, where each interaction creates a new record. Based on how files are shared and received, IP and trade risk may be identified.

The IP protection system 128 also enables differentiated access control policies for internal workforce members and external third parties, ensuring that data is shared only with authorized individuals under predefined security constraints. Organizations can configure role-based access controls (RBAC) and adaptive security rules to apply stricter controls when sensitive data is accessed by contractors, vendors, or business partners. These special controls may include automatic access revocation when an external party's engagement ends, limited-time or one-time access permissions for third-party users, context-aware restrictions, such as blocking access from high-risk geolocations, additional authentication layers for external access attempts, and attempts from different geographic locations within a preset period of time or other abnormal access activity, among others. By implementing these specialized controls, the IP protection system 128 ensures that highly sensitive data remains within trusted environments, reducing the risk of data breaches, insider threats, or regulatory violations.

The IP protection system 128 provides enterprise-wide visibility into where and how sensitive data is being shared across both internal and external networks. A real-time dashboard aggregates data from file-sharing platforms, email systems, virtual data rooms, and enterprise applications, displaying insights, such as which employees or external parties accessed sensitive data, where the data was shared (e.g., external domains, geographic locations), whether the data was classified as confidential, trade secret, or export-controlled, and the specific compliance policies applied to shared data. By offering real-time tracking and historical records, the IP protection system 128 enables organizations to detect unauthorized access, prevent data leaks, and enforce regulatory compliance measures effectively.

The IP protection system 128 also includes built-in tools for conducting security audits, risk assessments, and investigations related to workforce and trusted party access to sensitive information. These tools allow compliance officers and security teams to perform access audits to verify whether data-sharing activities comply with internal policies and legal requirements, identify anomalous access patterns, such as unauthorized file transfers or excessive data downloads by a single user, assess risk levels associated with specific data-sharing activities using AI-driven risk scoring models, and generate compliance reports for internal review or regulatory submission.

By continuously monitoring data-sharing activities and providing structured audit capabilities, the IP protection system 128 helps organizations proactively identify and mitigate potential security risks before they escalate into major incidents. Additionally, to support legal claims and regulatory investigations, the IP protection system 128 features automated evidence collection and documentation capabilities. When a potential data breach, intellectual property theft, or policy violation is detected, the system can capture and preserve audit logs of all access and sharing events, generate forensic reports containing detailed metadata about file access, recipient details, timestamps, and classification tags, integrate with eDiscovery tools to assist legal teams in compiling evidence for litigation, regulatory audits, or enforcement actions. This ensures that organizations can quickly respond to legal requests, demonstrate compliance with data protection laws, and protect intellectual property from misappropriation or unauthorized disclosure. By combining proactive security controls, real-time visibility, automated risk assessments, and forensic evidence collection, this risk management and compliance dashboard empowers organizations to safeguard their most sensitive data assets while maintaining regulatory and legal compliance.

The IP protection system 128 provides an AI-powered agent designed to support insider risk investigations by analyzing how individuals access, interact with, and share sensitive files. The AI agent operates within an enterprise security framework, ingesting raw access data from multiple sources to detect, assess, and respond to potential insider threats.

The AI agent coalesces raw data from various enterprise systems, including file access logs from document management and collaboration platforms, user activity data from cloud storage, email, messaging systems, and endpoint devices, external sharing records, including instances where files were transferred via email, third-party applications, or unauthorized storage solutions, and behavioral analytics, such as unusual file movement, excessive data downloads, or repeated access attempts outside normal working hours. By aggregating data across multiple sources, the IP system can construct a holistic activity profile of an insider's file interactions, allowing investigators to trace the flow of sensitive information within and beyond the organization's perimeter.

The AI agent 127 applies machine learning models and heuristic algorithms to identify anomalies in file access and sharing patterns that may indicate potential data exfiltration or policy violations, correlate events across different data sources to establish a chain of interactions leading to an insider risk event, and contextually classify the severity of potential incidents by considering factors such as file sensitivity, recipient classification, and prior user behavior. Once a risk is detected, the AI agent 127 automatically generates an investigation report, summarizing who accessed what files, when, and from where, how files were manipulated, including edits, downloads, and deletions. whether and how the data was shared externally, including recipient details and methods used, and a comparative risk analysis based on historical activity patterns of similar users or departments.

The AI agent 127 also facilitates automated workflows to support legal and compliance teams in responding to insider risk incidents. The AI agent 127 can generate digital evidence that documents the full lifecycle of a file, assisting in legal proceedings or regulatory audits, trigger automated containment actions, such as revoking access to compromised files or blocking further external sharing, and provide investigators with interactive insights, including graph-based visualizations of data movement, helping to streamline forensic analysis. By intelligently correlating raw access data, detecting risk patterns, and automating investigative workflows, the AI agent 127 enhances insider risk management while reducing the burden on security teams. This approach ensures that threats to intellectual property, trade secrets, and other sensitive corporate data can be proactively identified and mitigated with greater speed and accuracy.

The AI agent 127 can coalesces raw data from various enterprise systems, including file access logs from document management and collaboration platforms, user activity data from cloud storage, email, messaging systems, and endpoint devices, external sharing records, including instances where files were transferred via email, third-party applications, or unauthorized storage solutions. behavioral analytics, such as unusual file movement, excessive data downloads, or repeated access attempts outside normal working hours. The IP protection system 128 automatically collects and logs raw data whenever company users send files, tracking both sender and recipient interactions with those files. These interactions are recorded as sender/receiver activity logs, providing a detailed trail of file movements and access behaviors.

Additionally, the IP protection system 128 may integrate with existing cybersecurity tools that monitor how employees interact with internal repositories, enterprise applications, or other collaboration platforms. By extracting user activity data from insider risk and security monitoring solutions, the IP protection system 128 enhances visibility into potential data misuse or unauthorized disclosures. By aggregating data across multiple sources, the IP protection system 128 constructs a holistic activity profile of an insider's file interactions, allowing investigators to trace the flow of sensitive information within and beyond the organization's perimeter.

In some embodiments, the IP protection system 128 includes external systems and data sources as part of executing user-directed tasks that interfaces with the AI agent 127. This external interaction capability serves multiple purposes. First, the AI agent 127 may access and query external data sources, including web-based content and third-party services (e.g., open source intelligence searching), to gather contextual information relevant to a user's intent or to fulfill specific task objectives. For example, in the context of a multi-step use case, the AI agent 127 may autonomously initiate web searches, retrieve documents, or identify relevant resources needed to complete the task efficiently and accurately.

Second, the AI agent 127 also interfaces with the IP protection system 128 access usage history of how files are interacted with internally and shared externally to third parties via email or other file sharing collaboration tools. This architectural approach supports a broad range of use cases involving dynamic, AI-driven decision-making that is both contextually aware and policy-compliant.

Conventional datarooms and file sharing systems often require manual setup and maintenance of hierarchical folder structures. This process can be time-consuming and cumbersome for users, particularly when repeatedly sharing files with the same recipient. Additionally, implementing fine-grained access controls, such as per-file expiration policies, within traditional folder-based systems is typically difficult, unintuitive, or unsupported altogether.

The IP protection system 128 of the present disclosure addresses these limitations by introducing a virtual folder paradigm that enhances the user experience for file sharing workflows. In particular, the disclosed system enables individualized access controls for each shared file (e.g., file access that expires after a specified duration or is revoked based on predefined criteria) while also allowing multiple such files to be logically grouped into a single virtual folder.

In one example, when a user (the “sender”) shares a file with another user (the “receiver”), the system logs the sender-receiver pair associated with the transaction. Upon subsequent file sharing transactions involving the same sender-receiver pair, the system does not generate a new, standalone access link for each file. Instead, it creates or updates a virtual folder associated with that sender-receiver pair, dynamically aggregating active links to all previously shared files into a single accessible location. This approach eliminates the need for users to manually create and manage folders when engaging in ongoing or periodic file exchanges with specific recipients. Users may simply share files ad hoc, such as via email attachments or direct uploads, while the system automatically maintains a virtual folder that reflects the current state of shared content. Importantly, each file within the virtual folder retains its individual access control parameters, ensuring that access policies such as time-limited availability or permission revocation are preserved on a per-file basis.

Unlike conventional folders that physically store files within a hierarchical directory, the virtual folder is a dynamic, metadata-driven construct. It is implemented as a data structure that aggregates and presents links to files based on the sharing history between specific users. In some embodiments, the virtual folder is automatically updated to reflect the active state of its constituent links. For example, when a link expires or is otherwise deactivated in accordance with its access control policy, the system removes the corresponding entry from the virtual folder, ensuring that the recipient only sees currently accessible files. This virtual folder mechanism provides a streamlined and intuitive user experience for ongoing file sharing scenarios, reduces friction associated with folder management, and improves security and compliance through granular, enforceable access control.

FIG. 6 depicts a method for data risk intelligence and compliance according to an example implementation. The method can be performed by one or more computing devices operating within a networked computing environment, such as the networked computing environment 100 shown in FIG. 1.

At block 200, the method includes receiving, by a plugin or other component of the AI agent 127 or the IP protection system 128, a message from a user. The message can include a file attachment. The message can be received by the company network 120 from one or more client devices of the external systems 130. A plugin can be implemented in the email system 121, for example, to automatically invoke the core APIs of the AI agent 127 or the IP protection system 128 when an email is composed and/or sent using the e-mail system of the company network 120. When a user of the external systems 130 or the company network 120 composes an e-mail, relevant contextual data, including sender details, recipient information, file attachments, and message body content may be received and passed through the plugin to the core APIs.

At block 202, the method includes applying, by the plugin or other component of the AI agent 127 or the IP protection system 128, IP controls to the message and the file attachment(s). For example, the core APIs or other component of the AI agent 127 or the IP protection system 128 can process messages, including e-mails, text messages, and other messages in several ways. The core APIs can extract file attachments before the e-mails or messages are sent, classifying the files using the AI model to determine IP sensitivity or trade classification, performing IP and trade compliance checks to assess whether the file attachments can be shared with the intended recipient.

Applying the IP controls at block 202 can include extracting the file attachments from the message, classifying the file attachments using an AI model to determine IP sensitivity or trade classification for the file attachments, performing an IP and trade compliance check to assess whether the file attachments can be shared with an intended recipient of the message, generating the secure link to the file attachments; and inserting the secure link into the message in place of the file attachments.

At block 204, the method includes removing and storing, by the plugin, the file attachment based on the IP controls. The plugin can generate a secure link to the file instead of attaching it directly to the email. By replacing file attachments with secure links, the system reduces risk associated with sharing sensitive content externally. Additionally, access control mechanisms can be enforced, such as setting an expiration time on the link, ensuring that access is revoked after a specified duration. At block 206, the method includes sending, by the plugin, the message with a secure link to the file attachment based on the IP controls.

The AI agent 127 or the IP protection system 128 can also perform additional steps, including implementing a virtualized file access mechanism that renders the file attachment within a controlled viewer environment. The methods of the AI agent 127 or the IP protection system 128 can also include evaluating security risks over time, and implementing an automatic file access revocation system for the file attachment based on the evaluation of security risks.

The AI agent 127 or the IP protection system 128 can also perform additional steps, including cross-referencing a recipient of the message with a NDA database, and sending the message with the secure link to the file attachment based on the IP controls and the cross-referencing. The methods can also include applying a dynamic watermark to the file attachment, the dynamic watermark comprising at least one of: a recipient identifier, a timestamp, or access metadata. The methods can also include generating an audit log of access to the file attachment, the audit log comprising at least one of: an identify of a user accessing the file attachment, a timestamp of file access, an access duration of file access, or an attempted download of the file attachment. In other aspects, the method can include generating a dashboard interface. The dashboard interface can include an interface for monitoring, auditing, and enforcing security controls for the file attachment. The method can also include applying a machine learning model or heuristic algorithm to identify anomalies in access to the file attachment that may indicate potential data exfiltration or policy violations, and providing an automated workflow to support legal and compliance teams.

The company network 120, external systems 130, network 150 and other components described herein can include at least one processing circuit. Such a processing circuit can include, for example, one or more processors and one or more storage devices that are coupled to a local interface. The local interface can include, for example, a data bus with an accompanying address/control bus or any other suitable bus structure.

The one or more storage devices for a processing circuit can store data or components that are executable by the one or more processors of the processing circuit. For example, the AI agent 127, IP protection system 128, and/or other components can be stored in one or more storage devices and be executable by one or more processors. The AI agent 127, IP protection system 128, and/or other components described herein can be embodied in the form of hardware, as software components that are executable by hardware, or as a combination of software and hardware. If embodied as hardware, the components described herein can be implemented as a circuit or state machine that employs any suitable hardware technology. The hardware technology can include, for example, one or more microprocessors, discrete logic circuits having logic gates for implementing various logic functions upon an application of one or more data signals, application specific integrated circuits (ASICs) having appropriate logic gates, programmable logic devices (e.g., field-programmable gate array (FPGAs), and complex programmable logic devices (CPLDs)).

Also, one or more or more of the components described herein that include software or program instructions, such as the AI agent 127, IP protection system 128, and/or other components, can be embodied in any non-transitory computer-readable medium for use by or in connection with an instruction execution system such as, a processor in a computer system or other system. The computer-readable medium can contain, store, and/or maintain the software or program instructions for use by or in connection with the instruction execution system.

A computer-readable medium can include a physical media, such as magnetic, optical, semiconductor, and/or other suitable media. Examples of a suitable computer-readable media include, but are not limited to, solid-state drives, magnetic drives, or flash memory. Further, any logic or component described herein can be implemented and structured in a variety of ways. For example, one or more components described can be implemented as modules or components of a single application. Further, one or more components described herein can be executed in one computing device or by using multiple computing devices.

Further, any logic or applications described herein, including AI agent 127, IP protection system 128, and/or other components, can be implemented and structured in a variety of ways. For example, one or more applications described can be implemented as modules or components of a single application. Further, one or more applications described herein can be executed in shared or separate computing devices or a combination thereof. For example, a plurality of the applications described herein can execute in the same computing device, or in multiple computing devices in the same computing environment. Additionally, terms such as “application,” “service,” “system,” “engine,” “module,” and so on can be used interchangeably and are not intended to be limiting.

The processing units can implemented as one or more central processing units (CPUs) that performs arithmetic and logical operations, one or more application specific integrated circuits (ASICs), one or more graphics processing unit (GPUs), programmable logic devices (e.g., field-programmable gate array (FPGAs), programmable logic controllers (PLCs), programmable gate arrays, or other types of processors known to those skilled in the art and suitable for controlling the operations of the systems described herein.

The hardware resource layer of the cloud computing environment can provide hardware resources, such as compute resources, memory resources, and other resources. The compute resources can include one or more hardware components that perform computations to process data, and/or to execute computer-executable instructions of one or more application programs, operating systems, and/or other software. The compute resources can include one or more CPUs configured with one or more processing cores. The compute resources can include one or more GPUs configured to accelerate operations performed by one or more CPUs, and/or to perform computations to process data, and/or to execute computer-executable instructions of one or more application programs, operating systems, and/or other software. In some implementations, the compute resources can include one or more discrete GPUs. In some other implementations, the compute resources can include CPU and GPU components that are configured in accordance with a co-processing CPU/GPU computing model, wherein the sequential part of an application executes on the CPU and the computationally intensive part is accelerated by the GPU.

The compute resources can include one or more system-on-chip (SoC) components along with one or more other components, including, for example, one or more of the memory resources, and/or one or more of the other resources. The compute resources can be or can include one or more hardware components architected in accordance with an ARM® architecture. Alternatively, the compute resources can be or can include one or more hardware components architected in accordance with an x86 architecture. Those skilled in the art will appreciate the implementation of the compute resources can utilize various computation architectures, and as such, the compute resources should not be construed as being limited to any particular computation architecture or combination of computation architectures, including those explicitly disclosed herein.

The memory resources can include one or more hardware components that perform storage operations, including temporary or permanent storage operations. In some embodiments, the memory resources include volatile and/or non-volatile memory implemented in any method or technology for storage of information such as computer-readable instructions, data structures, program modules, or other data disclosed herein. Computer storage media includes, but is not limited to, RAM, ROM, EPROM, EEPROM, flash memory or other solid state memory technologies, CD-ROM, DVD, or other optical storage, magnetic cassettes, magnetic tape, magnetic disk storage or other magnetic storage devices, or any other medium which can be used to store data and which can be accessed by the compute resources.

The other resources can include any other hardware resources that can be utilized by the compute resources, the memory resources, or both to perform operations described herein. The other resources can include one or more input and/or output processors (e.g., network interface controller or wireless radio), one or more modems, one or more codec chipset, one or more pipeline processors, one or more fast Fourier transform (FFT) processors, one or more digital signal processors (DSPs), one or more speech synthesizers, and/or the like.

The hardware resources operating within the hardware resources layer can be virtualized by one or more virtual machine monitors (VMMs) (also known as “hypervisors”) operating within the virtualization/control layer to manage one or more virtual resources that reside in the virtual resource layer. The VMMs can be or can include software, firmware, and/or hardware that alone or in combination with other software, firmware, and/or hardware, manages one or more virtual resources operating within the virtual resource layer.

The virtual resources operating within the virtual resource layer can include abstractions of at least a portion of the compute resources, the memory resources, the other resources, or any combination thereof. These abstractions are referred to herein as virtual machines (VMs). Each of the VMs can execute one or more applications.

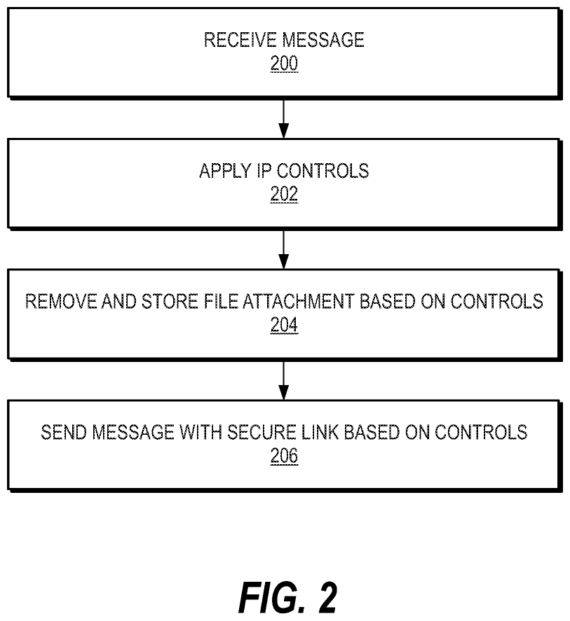

The flowcharts of FIG. 2 illustrates the functionality and operation of methods implemented within the computing environment 100. If embodied in software, each block in these flowcharts can represent a module, segment, or portion of code including program instructions to implement the specified logical function(s). The program instructions can be embodied as source code, written in human-readable programming languages such as Python®, Java®, or C++, or as machine code including numerical instructions executable by one or more processors. The machine code can be compiled or converted from the source code or other high-level programming languages. If embodied in hardware, each block can represent a circuit or a set of interconnected circuits to implement the specified logical function(s).

Although the flowchart of FIG. 2 depicts a specific order of execution, the execution order can vary in alternative implementations. For example, the sequence of execution for two or more blocks can differ or be rearranged relative to the order shown. Additionally, two or more blocks are shown consecutively in FIG. 2 can be executed concurrently or partially concurrently. Furthermore, in some implementations, one or more blocks shown in FIG. 2 can be omitted or skipped entirely. Any such variations, including the addition of counters, state variables, warning semaphores, or troubleshooting messages for enhanced utility, performance measurement, or system monitoring, are understood to fall within the scope of the present disclosure.

Any logic or application described can be embodied in a non-transitory computer-readable medium for use by or in connection with an instruction execution system such as the computer system or the cloud computing environment described above, as examples. In this context, the logic can include instructions and declarations that can be retrieved from the computer-readable medium and executed by the instruction execution system.

The computer-readable medium can include a variety of physical media, such as magnetic, optical, or semiconductor media. Specific examples of suitable computer-readable media include magnetic tapes, magnetic floppy diskettes, magnetic hard drives, memory cards, solid-state drives (SSDs), universal serial bus (USB) flash drives, and optical discs such as compact discs (CDs) or digital versatile discs (DVDs). The medium can also include random access memory (RAM), such as static random access memory (SRAM) or dynamic random access memory (DRAM), and other volatile memory. Nonvolatile memory, such as magnetic random access memory (MRAM), read-only memory (ROM), programmable read-only memory (PROM), erasable programmable read-only memory (EPROM), and electrically erasable programmable read-only memory (EEPROM), are also suitable computer-readable media.

The logic or applications described herein can be implemented and structured in various ways. For instance, one or more modules can be implemented as components of a single application. Alternatively, one or more modules can execute in shared or separate computer systems or as part of a cloud computing environment. For example, multiple modules can execute within the same computer system or across different systems and/or devices connected over the system bus and/or one or more networks, such as the network 170.

Combinatorial language, such as “at least one of X, Y, and Z” or “at least one of X, Y, or Z,” unless indicated otherwise, is used in general to identify one, a combination of any two, or all three (or more if a larger group is identified) thereof, such as X and only X, Y and only Y, and Z and only Z, the combinations of X and Y, X and Z, and Y and Z, and all of X, Y, and Z. Such combinatorial language is not generally intended to, and unless specified does not, identify or require at least one of X, at least one of Y, and at least one of Z to be included.

The above-described examples of the present disclosure are merely possible examples of implementations set forth for a clear understanding of the principles of the disclosure. Many variations and modifications can be made without departing substantially from the spirit and principles of the disclosure. All such modifications and variations are intended to be included herein within the scope of this disclosure and protected by the following claims.

Therefore, the following is claimed:

1. A computing device, comprising:
a memory device to store computer-readable instructions thereon; and
at least one processing device configured through execution of the computer-readable instructions to:
receive a message from a user, the message including a file attachment;
apply IP controls to the message and the file attachment;
remove and store the file attachment based on the IP controls; and
send the message with a secure link to the file attachment based on the IP controls.

2. The computing device according to claim 1, wherein, to apply the IP controls to the message and the file attachment, the at least one processing device is further configured to:
extract the file attachment from the message;
classify the file attachment using an AI model to determine IP sensitivity or trade classification for the file attachment;
perform an IP and trade compliance check to assess whether the file attachment can be shared with an intended recipient of the message;
generate the secure link to the file attachment; and
insert the secure link into the message in place of the file attachment.

3. The computing device according to claim 1, wherein the at least one processing device is further configured to implement a virtualized file access mechanism that renders the file attachment within a controlled viewer environment.

4. The computing device according to claim 1, wherein the at least one processing device is further configured to:
evaluate security risks over time; and
implement an automatic file access revocation system for the file attachment based on the evaluation of security risks.

5. The computing device according to claim 1, wherein the at least one processing device is further configured to:
cross-reference a recipient of the message with a NDA database; and
send the message with the secure link to the file attachment based on the IP controls and the cross-reference.

6. The computing device according to claim 1, wherein the at least one processing device is further configured to generate a virtual folder for a sender-receiver pair, the virtual folder providing access to a plurality of active links.

7. The computing device according to claim 1, wherein the at least one processing device is further configured to generate an audit log of access to the file attachment, the audit log comprising at least one of: an identify of a user accessing the file attachment, a timestamp of file access, an access duration of file access, or an attempted download of the file attachment.

8. The computing device according to claim 1, wherein the at least one processing device is further configured to generate a dashboard interface, the dashboard interface comprising an interface for monitoring, auditing, and enforcing security controls for the file attachment.

9. The computing device according to claim 1, wherein the at least one processing device is further configured to apply a machine learning model or heuristic algorithm to identify anomalies in access to the file attachment that may indicate potential data exfiltration or policy violations.

10. The computing device according to claim 1, wherein the at least one processing device is further configured to provide an automated workflow to support legal and compliance teams.

11. A computer-implemented method, comprising:
receiving, by an email plugin, a message from a user, the message including a file attachment;
applying, by the email plugin, IP controls to the message and the file attachment;
removing and storing, by the email plugin, the file attachment based on the IP controls; and
sending, by the plugin, the message with a secure link to the file attachment based on the IP controls.

12. The method according to claim 11, wherein applying the IP controls to the message and the file attachment comprises:
extracting the file attachment from the message;
classifying the file attachment using an AI model to determine IP sensitivity or trade classification for the file attachment;
performing an IP and trade compliance check to assess whether the file attachment can be shared with an intended recipient of the message;
generating the secure link to the file attachment; and
inserting the secure link into the message in place of the file attachment.

13. The method according to claim 11, further comprising implementing a virtualized file access mechanism that renders the file attachment within a controlled viewer environment.

14. The method according to claim 11, further comprising:
evaluating security risks over time; and
implementing an automatic file access revocation system for the file attachment based on the evaluation of security risks.

15. The method according to claim 11, further comprising:
cross-referencing a recipient of the message with a NDA database; and
sending the message with the secure link to the file attachment based on the IP controls and the cross-referencing.

16. The method according to claim 11, further comprising applying a dynamic watermark to the file attachment, the dynamic watermark comprising at least one of: a recipient identifier, a timestamp, or access metadata.

17. The method according to claim 11, further comprising generating an audit log of access to the file attachment, the audit log comprising at least one of: an identify of a user accessing the file attachment, a timestamp of file access, an access duration of file access, or an attempted download of the file attachment.

18. The method according to claim 11, further comprising generating a dashboard interface, the dashboard interface comprising an interface for monitoring, auditing, and enforcing security controls for the file attachment.

19. The method according to claim 11, further comprising applying a machine learning model or heuristic algorithm to identify anomalies in access to the file attachment that may indicate potential data exfiltration or policy violations.

20. The method according to claim 11, further comprising providing an automated workflow to support legal and compliance teams.
